(19) United States
(12) Patent Application Publication
(10) Pub. No.: US 2025/0292616 A1
(43) Pub. Date: Sep. 18, 2025

(54) METHOD OF OCCLUSION-ROBUST TRANSFORMER FOR ACCURATE FACIAL LANDMARK DETECTION, ASSOCIATED APPARATUS AND ASSOCIATED COMPUTER-READABLE MEDIUM

(71) Applicant: MEDIATEK INC., Hsinchu City (TW)

(72) Inventors: Yen-Yu Lin, Hsinchu City (TW); Jui-Che Chiang, New Taipei City (TW); Hou-Ning Hu, Hsinchu City (TW)

(73) Assignee: MEDIATEK INC., Hsinchu City (TW)

(21) Appl. No.: 19/079,450

(22) Filed: Mar. 13, 2025

Related U.S. Application Data
(60) Provisional application No. 63/566,418, filed on Mar. 18, 2024.

(51) Int. Cl. G06V 40/16; G06T 9/00; G06V 10/26; G06V 10/771

(52) U.S. Cl. CPC G06V 40/171; G06T 9/00; G06V 10/26; G06V 10/771

(57) ABSTRACT

A method of occlusion-robust transformer for accurate facial landmark detection, an associated apparatus and an associated computer-readable medium are provided. The method may include: utilizing the processing circuit to run an occlusion-robust transformer framework to start performing inference with a trained model of the occlusion-robust transformer framework according to at least one input image, for performing facial landmark detection; and during performing the inference with the trained model, performing occlusion-aware cross-attention processing on any input image among the at least one input image to obtain an occlusion map for feature recovery by merging two feature maps respectively corresponding to two code sequences of occluded and non-occluded image patches of the any input image, in order to generate facial landmark information regarding the facial landmark detection.

### CROSS REFERENCE TO RELATED APPLICATIONS

This application claims the benefit of U.S. Provisional Application No. 63/566,418, filed on Mar. 18, 2024. The content of the application is incorporated herein by reference.

### BACKGROUND

The present invention is related to image processing, and more particularly, to a method of occlusion-robust transformer for accurate facial landmark detection, an associated apparatus and an associated computer-readable medium.

According to the related art, although facial landmark detection (FLD) has gained significant progress, existing FLD methods still suffer from performance drops on partially non-visible faces, such as faces with occlusions or under extreme lighting conditions or poses. Thus, a novel method and associated architecture are needed for solving the problems without introducing any side effect or in a way that is less likely to introduce a side effect.

### SUMMARY

It is an objective of the present invention to provide a method of occlusion-robust transformer for accurate facial landmark detection, an associated apparatus and an associated computer-readable medium, in order to solve the above-mentioned problems.

At least one embodiment of the present invention provides a method of occlusion-robust transformer for accurate facial landmark detection, where the method can be applied to a processing circuit within an electronic device. For example, the method may comprise: utilizing the processing circuit to run an occlusion-robust transformer framework to start performing inference with a trained model of the occlusion-robust transformer framework according to at least one input image, for performing facial landmark detection; and during performing the inference with the trained model, performing occlusion-aware cross-attention processing on any input image among the aforementioned at least one input image to obtain an occlusion map for feature recovery by merging two feature maps respectively corresponding to two code sequences of occluded and non-occluded image patches of the any input image, in order to generate facial landmark information regarding the facial landmark detection.

At least one embodiment of the present invention provides an apparatus that operates according to the above method, where the apparatus may comprise at least the processing circuit within the electronic device. According to some embodiments, the apparatus may comprise the whole of the electronic device.

At least one embodiment of the present invention provides a computer-readable medium related to the above method, where the computer-readable medium may store a program code which causes the processing circuit to operate according to the method when executed by the processing circuit.

It is an advantage of the present invention that, the method of the present invention, as well as the associated apparatus such as the processing circuit and the electronic device, can perform accurate facial landmark detection with ease, no matter whether any face shown in the aforementioned at least one input images is partially non-visible or not, and therefore can enhance the overall performance. To address the issue in the related art, the present invention provides ORFormer, a novel transformer-based method that can detect nonvisible regions and recover their missing features from visible parts. Specifically, ORFormer associates each image patch token with one additional learnable token called the messenger token. The messenger token aggregates features from all but its patch. This way, the consensus between a patch and other patches can be assessed by referring to the similarity between its regular and messenger embeddings, enabling non-visible region identification. The method of the present invention then recovers occluded patches with features aggregated by the messenger tokens. Leveraging the recovered features, ORFormer compiles high-quality heatmaps for the downstream FLD task. Extensive experiments show that the method of the present invention generates heatmaps resilient to partial occlusions. By integrating the resultant heatmaps into existing FLD methods, the method of the present invention performs favorably against the state of the arts on challenging datasets such as WFLW and COFW.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an overview of an ORFormer according to an embodiment of the present invention, where: (a) for each patch Pᵢ, the present invention architecture may introduce a patch token Xᵢ and a learnable messenger token Mᵢ for occlusion detection and handling; (b) the messenger token computes attention with patch tokens other than its corresponding one; and (c) the present invention architecture may detect occlusion by evaluating the dissimilarity between the regular embedding X′ᵢ and the messenger embedding M′ᵢ, and then recover occluded features based on the messenger embedding which is aggregated from other image patches, if occlusion is present in patch Pᵢ.

FIG. 2 is a diagram illustrating an overview of a method of occlusion-robust transformer (ORFormer) for accurate facial landmark detection according to an embodiment of the present invention, where: (a) the present invention architecture may first train a quantized heatmap generator, which takes an image I as input and generates its edge heatmaps H, and after pre-training, the prior knowledge of unoccluded faces is encoded in the codebook C and decoder D; and (b) with the frozen codebook and decoder, the present invention architecture may introduce the ORFormer to generate the occlusion map α and two code sequences S_{I} and S_{M}, leading to quantized features Z_{I} and Z_{M}, where the recovered feature Z_{rec} is yielded by merging Z_{I} and Z_{M} with patch-specific weights given in α, and is used to produce occlusion-robust heatmaps H_{rec}.

FIG. 3 is a diagram illustrating a network architecture of the ORFormer according to an embodiment of the present invention, where: the ORFormer takes image patches P as input and generates two code sequences S_{I} and S_{M} via the codebook prediction head; and while S_{I} is computed by referring to the image patch tokens, S_{M} is by the messenger tokens, and the occlusion map α represents the patch-specific occlusion likelihood and is inferred by the occlusion detection head.

FIG. 4 is a diagram illustrating an integration of the ORFormer into an existing FLD method, where: the ORFormer is adopted for occlusion detection and feature recovery, resulting in high-quality heatmaps; and the generated heatmaps serve as an extra input to an FLD method, and offer the recovered features to make the FLD method robust to occlusions.

FIG. 5 is a diagram illustrating an electronic device involved with the method according to an embodiment of the present invention.

FIG. 6 is a flowchart of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

### 1. Introduction

Facial landmark detection (FLD) aims to localize specific key points on human faces, such as those on eyes, noses, and mouths. It is pivotal for numerous downstream applications, such as face recognition, facial expression recognition, head pose estimation, and augmented reality Recent advances in deep neural networks have significantly enhanced facial landmark detection. However, existing FLD methods suffer from performance drops on partially non-visible faces caused by occlusions, extreme lighting conditions, or extreme head rotations, because the features extracted from non-visible regions are corrupted. An FLD method with non-visible region detection and reliable feature extraction is in demand.

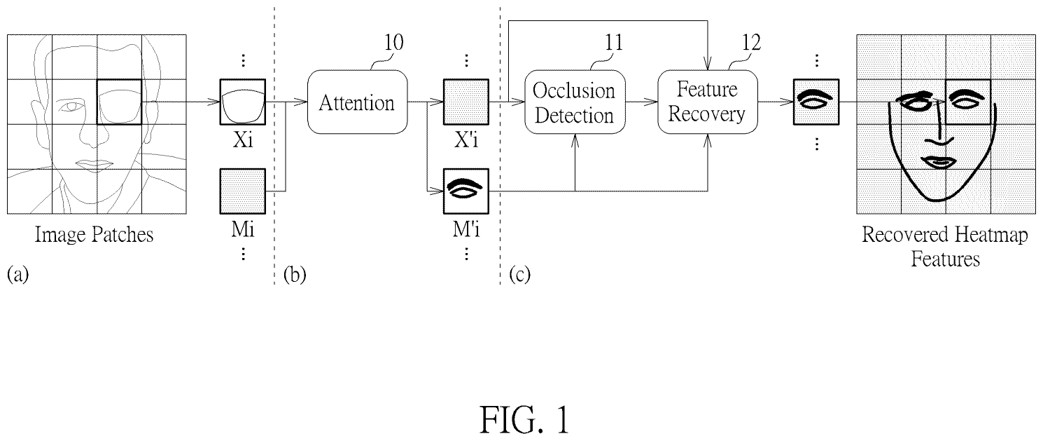

According to the present invention, an occlusion-robust transformer is introduced, called ORFormer, which can identify non-visible regions and recover their missing features, and is applied to generate high-fidelity heatmaps resilient to challenging scenarios. As illustrated in FIG. 1, the ORFormer builds on Vision Transformer (see Dosovitskiy et al., “An image is worth 16×16 words: Transformers for image recognition at scale”, arXiv preprint arXiv: 2010.11929, 2020; “Dosovitskiy” hereinafter), where image patch tokens interact with each other via the self-attention mechanism 10 (labeled “Attention” for brevity). For non-visible part detection, each patch token Xᵢ is associated with an extra learnable token Mᵢ called messenger token.

The messenger token Mᵢ simulates occlusion present in patch i and aggregates features from all patch tokens except Xᵢ. Subsequently, the occlusion detection module 11 (labeled “Occlusion Detection” for brevity) accesses the disparity between the regular patch embedding X′ᵢ and the messenger embedding M′ᵢ to determine if occlusion is present in patch i. For occlusion handling, the feature recovery module 12 (labeled “Feature Recovery” for brevity) recovers the missing features of the occluded patch by a convex combination of X′ᵢ and M′ᵢ with the combination coefficient predicted by the occlusion detection module 11. The resulting features are then utilized to generate heatmaps, and the proposed mechanism makes the output heatmaps remain robust in extreme scenarios.

The high-quality heatmaps generated by ORFormer is integrated as complementary information into existing landmark detection methods. The method achieves state-of-the-art performance on multiple benchmark datasets, including the large dataset named Wider Facial Landmarks in-the-wild (WFLW) (see Wu et al., “Look at Boundary: A Boundary-Aware Face Alignment Algorithm”, CVPR, 2018) and the challenging face landmark dataset named Caltech Occluded Faces in the Wild (COFW) (see Burgos-Artizzu et al., “Robust face landmark estimation under occlusion”, ICCV, 2013), showcasing the robustness of the method in handling partially non-visible faces.

According to the present invention, first, a novel occlusion-robust transformer, ORFormer, which utilizes the proposed learnable messenger token is proposed to simulate potential occlusions and recover missing features. The ORFormer enables a transformer to detect and handle non-visible tokens in a general way. Second, the ORFormer is applied for robust heatmap generation, thereby enhancing the applicability of existing FLD methods to partially non-visible faces. Third, the method performs favorably against state-of-the-art facial landmark detection methods on two challenging datasets, WFLW and COFW, showcasing its robustness to extreme cases.

### 2. Related Work

### 2.1. Facial Landmark Detection

Most FLD methods rely on coordinate regression and/or heatmap regression. The former directly estimates the landmark coordinates of a face. The latter predicts a heatmap for each landmark and completes FLD with post-processing.

### Coordinate Regression

Some methods employ linear layers as decoders to regress landmarks from convolutional neural network (CNN) features. For example, a new loss function is designed for improving landmark supervision. Facial contours are utilized to impose constraints on landmark supervision while providing a dataset with various extreme cases. Fourier feature pooling may be used to handle highly nonlinear relationships between images and facial shapes. These methods offer end-to-end trainable solutions.

To leverage the self-attention mechanism in Transformer for facial structures exploration, some studies utilize the transformer decoder to learn the mapping between CNN features and landmarks. For example, a coarse-to-fine decoder may be used to focus on sparse local patches. Another scheme suggests learning landmark queries along pyramid CNN features. However, these schemes have some challenges in handling partial occlusions because linear layers in CNN and global feature dependence in transformers are sensitive to partial occlusions.

### Heatmap Regression

Inspired by the advances in heatmap generation, some studies integrate heatmap regression into facial landmark detection. They convert landmark annotations to heatmaps for model supervision. A study estimates uncertainty and visibility likelihood with heatmaps for stable model convergence. A stacked hourglass network is employed with intermediate heatmap supervision and Argmax operator is utilized to obtain landmarks. However, Argmax in heatmap regression limits direct supervision by landmarks due to its non-differentiable nature.

Recent studies, such as replacing Argmax with other differential decoders, enable heatmap regression methods to be end-to-end trainable and supervised by both heatmaps and landmarks. For example, a study reduces heatmap regression to confidence score and offset prediction to avoid heavy upsampling layers and the use of Argmax. With the aid of differential decoders, a scheme (see Huang et al., “ADNet: Leveraging Error-Bias Towards Normal Direction in Face Alignment”, ICCV, 2021) and another scheme (see Zhou et al., “STAR Loss: Reducing Semantic Ambiguity in Facial Landmark Detection”, CVPR, 2023) design new loss functions with both landmark and heatmap supervision to alleviate the negative impact caused by landmark annotation ambiguities. The deep equilibrium model is utilized to compute cascaded landmark refinement. The capability of heatmap regression methods that can be supervised by both landmarks and heatmaps while preserving facial structures has propelled them to the state-of-the-art status.

However, the aforementioned coordinate regression and heatmap regression methods are vulnerable to faces with partial occlusions, under extreme lighting conditions, or in extreme head rotations due to feature occlusion and corruption.

### 2.2. Occlusion-Robust Facial Landmark Detection

Three major categories of methodologies for occlusion-robust facial landmark detection are discussed as follows:

Methods in the first category estimate the probability of occlusion occurrence for each landmark and alleviate the negative impact of corrupted features computed in occluded areas. For example, joint landmark location, uncertainty, occlusion probabilities, and/or visibility prediction are used. However, these methods rely on additional annotations indicating whether a landmark is occluded or not, while the proposed method does not require these annotations.

The second category explores the consensus among image patches to identify occluded ones. For example, Burgos-Artizzu et al. propose a method that enforces regressors focusing on different image patches to reach a consensus, trusting those using local features from non-occluded areas. While their method and the proposed method share a similar concept, their method ignores the occluded features without recovering them, restricting the ability of occluded landmark detection. In contrast, the proposed method proposes the messenger token, which aggregates information from non-occluded areas and enables feature recovery for occluded patches.

The third category utilizes global context to deal with occlusions. Global context is introduced directly into a fully convolutional neural network. A geometry-aware module is used to excavate geometric relationships between different facial components, while Zhu et al., “Occlusion-robust Face Alignment using A Viewpoint-invariant Hierarchical Network Architecture”, CVPR, 2022 model the hierarchies between facial components. However, these works do not explicitly detect the occluded areas and therefore do not recover features for these areas, being suboptimal for significant occlusions.

### 2.3. Transformer for Feature Recovery

Transformers (for example, see Dosovitskiy) have been widely adopted in vision tasks. Transformers leverage attention mechanisms to capture long-range dependencies between tokens, but are sensitive to feature corruption or partial occlusions.

To address this issue, cross-attention is utilized to recover occluded features between different frames in the context of object re-identification. However, the method thereof relies on multiple frames, whereas our approach focuses on recovering occluded features within a single image. Park et al., “HandOccNet: Occlusion-Robust 3D Hand Mesh Estimation Network”, CVPR, 2022 proposes a method for 3D hand mesh estimation that involves training a CNN block to separate primary and secondary features, followed by utilizing cross-attention to recover occluded features. In contrast, our method integrates occlusion detection and handling mechanisms into a single transformer, enabling adaptive detection and recovery of occluded features within a single frame.

Zhou et al., “Towards Robust Blind Face Restoration with Codebook Lookup Transformer”, NeurIPS, 2022 (“Zhou” hereinafter) pre-train a quantized autoencoder, employ a ViT model (see Dosovitskiy), and utilize self-attention to recover corrupted features for blind face restoration. While their approach shares similarities with ours, relying on self-attention with partially corrupted features may fail since attention values of the occluded tokens cannot be faithfully computed. To alleviate this issue, we develop messenger tokens and present a module to adaptively combine the regular and messenger embeddings for feature recovery.

### 3. Proposed Method

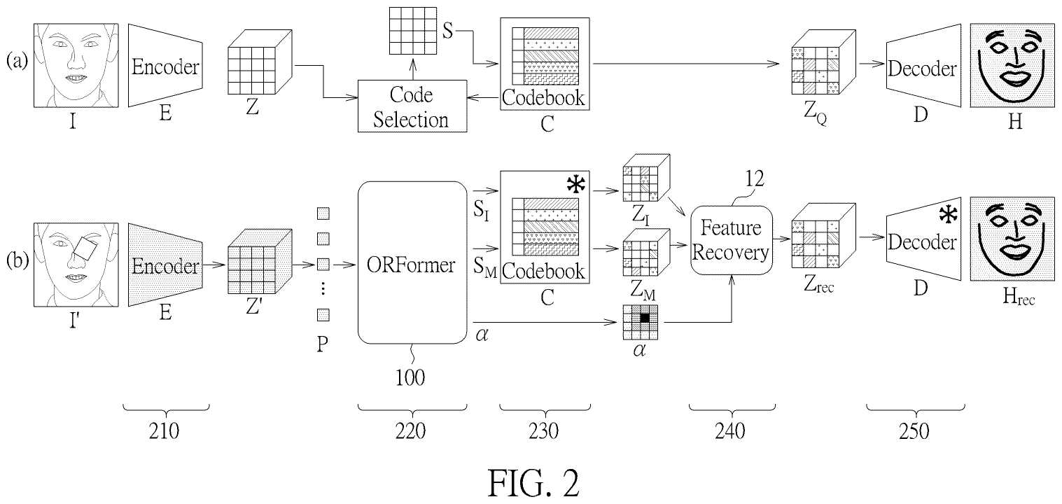

The section presents ORFormer, a general method that can be integrated into a regular transformer for occlusion detection and handling. FIG. 2 illustrates our method. Firstly, we adopt the concept of vector quantization (see Aaron van den Oord, et al., “Neural discrete representation learning”, NeurIPS, 2017; “Van den Oord” hereinafter), similar to the approach in Codeformer (see Zhou), and pre-train a quantized heatmap generator (Section 3.1). Subsequently, the learned discrete codebook and decoder are employed as a prior for heatmap generation. Leveraging this learned prior, we utilize ORFormer for code sequence prediction and feature recovery for the partially occluded image patches (Section 3.2). Lastly, with the aid of ORFormer, we integrate our heatmaps generated from recovered features into the existing FLD methods (Section 3.3).

### 3.1. Quantized Heatmap Generator

To enhance robustness against occlusions during heatmap generation, we include the training of a quantized heatmap generator. By training this generator on faces without occlusions, we can learn a high-dimensional latent space tailored explicitly for heatmap generation under ideal conditions. With the learned codebook, we reduce uncertainty in restoring occluded features, as the code items are learned from non-occluded faces.

As illustrated in FIG. 2(a), an unoccluded face image I∈R^{h×w×3} is encoded into the latent space Z∈R^{m×n×d} by an encoder E. Following the principles in the Vector Quantised-Variational AutoEncoder (VQVAE) (see Van den Oord), each patch Z^{i,j} in the encoded features Z is replaced with the nearest dictionary item, i.e., code, in the learnable codebook C={cₛ∈R^{d}}ₛ₌₀^{N-1} of N codes to obtain the quantized feature Z_{Q}∈R^{m×n×d} and its corresponding code index sequence S e {0, 1, . . . ,N−1}^{h×w}, i.e.,

$${Z}_{Q}^{i , j} = arg {min}_{{c}_{s} ∈ C} {‖ {Z}^{i , j} - {c}_{s} ‖}_{2} and \qquad ( 1 )$$

$${S}^{i , j} = arg {min}_{s} {‖ {Z}^{i , j} - {c}_{s} ‖}_{2} .$$

Subsequently, the decoder D generates the edge heatmaps H∈R^{h×w×N}^{_{E}} based on the quantized feature Z_{Q}, where N_{E} is the number of edges (facial contours) per face. In this work, we adopt the same edge heatmap definition as that in Wu et al.

Loss Functions. To train the quantized heatmap generator with a learnable codebook, an image-level loss L_{img} is utilized. In addition, an intermediate latent space loss Lₗₐₜₑₙt is incorporated to minimize the distance between the codebook C and the encoded feature Z. These loss functions are defined by

$${L}_{img} = {‖ H - \hat{H} ‖}_{2}^{2} and \qquad ( 2 )$$

$${L}_{latent} = {‖ sg ( Z ) - {Z}_{Q} ‖}_{2}^{2} + β {‖ Z - sg ( {Z}_{Q} ) ‖}_{2}^{2} ,$$

where Ĥ is the ground-truth edge heatmaps, sg(·) stands for the stop-gradient operator, and β is a hyper-parameter used for loss balance. The complete loss function for learning the codebook heatmap generator L_{codebook} is given by

$${L}_{codebook} = {L}_{img} + {λ}_{latent} \cdot {L}_{latent} , \qquad ( 3 )$$

where λₗₐₜₑₙₜ is a hyper-parameter used for loss balance.

### 3.2. ORFormer

Given an occluded or partially non-visible face as input, conventional nearest-neighbor searching described in Equation (1) may fail on the occluded patches due to their feature corruption. However, relying solely on self-attention in transformers, e.g. Zhou, is insufficient in heatmap generation since the attention map calculated with corrupted features no longer faithfully captures the relationships between patches. To this end, we propose ORFormer to detect occluded patches and recover their features.

As shown in FIG. 2(b), the proposed ORFormer 100 is introduced after training the heatmap generator. The ORFormer 100 takes as input image patches P={Pₖ}ₖ₌₀^{m×n-1} from the features Z′, which are extracted by the encoder E. The ORFormer 100 employs both regular and messenger tokens for computing patch features. It generates the patch-specific occlusion map α∈R^{m×n} and two code sequences, S_{I}∈{0, 1, . . . ,N−1}^{m×n} and S_{M}={0, 1, . . . ,N−1}^{m×n}. While S_{I} is computed from regular tokens and brings information from all patches, S_{M} is derived from messenger tokens and is occlusion-aware. Based on the codes in S_{I} and S_{M}, quantized features Z_{I} and Z_{M} are produced by referring to codebook C. Z_{I} and Z_{M} are merged by based on the occlusion map α in a patch-specific manner, and form the recovered feature Z_{rec}. Finally, Z_{rec} along with the pre-trained decoder is used to generate the heatmaps H_{rec}.

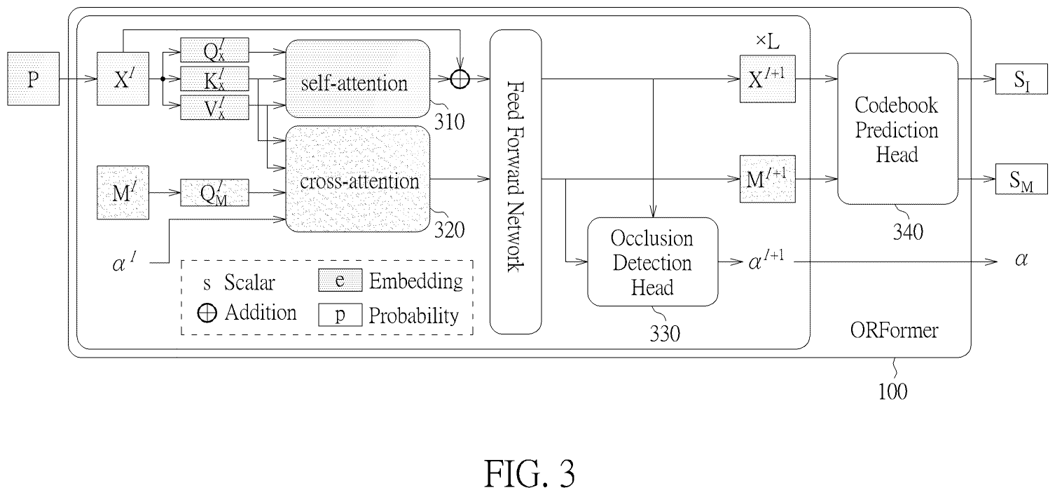

We freeze the codebook C and decoder D after the pre-training stage while fine-tuning the encoder E to facilitate heatmap generation under feature occlusion. The proposed ORFormer 100, shown in FIG. 3, is elaborated as follows. The ORFormer 100 comprises a self-attention module 310, a cross-attention module 320, an occlusion detection head module 330, and codebook prediction head module 340.

As shown in FIG. 3, the ORFormer 100 is a transformer with L layers. At each layer l, it computes self-attention among regular image patch tokens by

$${X}^{l + 1} = FFN \{ softmax ( {{Q}_{X}^{l} ( {K}_{X}^{l} )}^{T} ) {V}_{X}^{l} + {X}^{l} \} , \qquad ( 4 )$$

where queries Q_{X}^{l}, keys K_{X}^{l}, and values V_{X}^{l} are obtained from patch tokens X^{l} through linear embeddings. Residual learning and a feed-forward network (FFN) are employed here.

In addition to conventional self-attention between image patch tokens, the messenger tokens are introduced, denoted as M^{l}, one for each patch. The messenger tokens are designed to simulate feature occlusion. As shown in FIG. 3, only their queries Q_{M}^{l} are computed, each of which is used to aggregate features from all but its corresponding patch token via cross-attention:

$${M}^{l + 1} = FFN \{ softmax ( {A}_{cross} ( {Q}_{M}^{l} , {K}_{X}^{l} ) ) {V}_{X}^{l} \} , \qquad ( 5 )$$

where

$${{A}_{cross} ( {Q}_{M}^{l} , {K}_{X}^{l} )}^{i , j} = \{ \begin{matrix}0 , & if i = j , \\ {( {{Q}_{M}^{l} ( {K}_{X}^{l} )}^{T} )}^{i , j} , & otherwise .\end{matrix} \qquad ( 6 )$$

Equation (6) computes the cross-attention score between the i-th messenger token and the j-th image patch token. By excluding features from the corresponding patch, the resultant messenger tokens M^{l+1} encode features borrowed from other image tokens, simulating feature occlusion.

Following the attention mechanism and the feed-forward network, an occlusion detection head 330 is introduced to detect occluded patches by referring to the dissimilarity between the image patch embedding X^{l+1} and the messenger embedding M^{l+1}. A patch-specific occlusion map α^{l+1}={αₖ^{l+1}}ₖ₌₀^{m×n-1} is obtained:

$${α}_{k}^{l + 1} = σ ( {W}^{l + 1} \cdot dist ( {X}_{k}^{l + 1} , {M}_{k}^{l + 1} ) ) , \qquad ( 7 )$$

where the function dist (·, ·) computes the element-wise squared difference between the two embeddings. W^{l+1} is a fully connected layer transforming the embedding returned by dist into a scalar. σ(*) is the sigmoid function ensuring αₖ^{l+1} ranges between 0 and 1. Higher αₖ^{l+1} indicates that patch k is more likely to be occluded.

After obtaining the occlusion map α^{l}∈R^{m×n} at the (l−1)-th layer, the messenger tokens at the l-th layer are allowed to suppress feature aggregation from occluded patches. Specifically, the cross-attention adonted hv messenger tokens in Fonation (6) is modified to

$${{A}_{cross} ( {Q}_{M}^{l} , {K}_{X}^{l} )}^{i , j} = \{ \begin{matrix}0 , & if i = j , \\ ( 1 - {α}_{j}^{l} ) {( {{Q}_{M}^{l} ( {K}_{X}^{l} )}^{T} )}^{i , j} , & otherwise .\end{matrix} \qquad ( 8 )$$

Since αⱼ^{l} gives the likelihood of occlusion occurrence in the j-th image patch, the coefficient (1−αⱼ^{l}) in Equation (8) prevents a messenger token from aggregating features from patch j with a larger value of αⱼ^{l}. At the first layer, the initial occlusion map α¹ is set to 0. At the last layer, i.e., the L-th layer, the resultant occlusion map α^{L+1} will be used in the following step for feature recovery, and is denoted as a for simplicity in FIG. 2(b).

In FIG. 3, the image embedding X^{L+1} and the messenger embedding ^{ML+1} produced in the last layer of ORFormer are fed into a codebook prediction head 340. This head 340 predicts the code sequence S_{I}={0, 1, . . . ,N−1}^{m×n} based on the image embedding X^{L+1}, where each entry in S_{I} searches the code index for its corresponding patch via Equation (1). The quantized features Z_{I}∈R^{m×n×d} are produced by retrieving the corresponding m×n code items from the codebook C. Similarly, the other code sequence S_{M} and quantized features Z_{M} are generated based on the messenger embedding M^{L+1}.

The quantized features Z_{I} and Z_{M} store complementary information. While Z_{I} considers all patches but is sensitive to corrupted features, Z_{M} focuses on non-occluded patches but ignores the original patch features P as shown in FIG. 3. The predicted occlusion map α∈R^{m×n} is used to recompose the final recovered features Z_{rec}∈R^{m×n×d} by merging Z_{I} and Z_{M} in a patch-specific manner, i.e.,

$${Z}_{rec} = ( 1 - α ) ⊗ {Z}_{I} + α ⊗ {Z}_{M} , \qquad ( 9 )$$

where A⊗B denotes element-wise multiplication between A and B along the third dimension of B.

After the pre-training stage, we learn the ORFormer and fine-tune the encoder E while keeping the codebook C and the decoder D fixed. We employ the cross-entropy loss for code sequence prediction L_{code} on both S_{I} and S_{M} via

$${L}_{code} ( \hat{S} ) = {\sum }_{k = 0}^{m \times n - 1} - {S}_{k} log ( {\hat{S}}_{k} ) , \qquad ( 10 )$$

where Ŝ∈{S_{I}, S_{M}} and the ground truth of the code sequence S is obtained from the pre-trained heatmap generator mentioned in Section 3.1. Image-level loss L_{img} given in Equation (2) is employed between H_{rec} and Ĥ. The complete loss function for learning ORFormer L_{ORFormer} is

$${L}_{ORFormer} = {L}_{code} ( {S}_{I} ) + {L}_{code} ( {S}_{M} ) + {λ}_{img} \cdot {L}_{img} , \qquad ( 11 )$$

where λ_{img} is a hyper-parameter used for loss balance.

### 3.3. Integration with FLD Methods

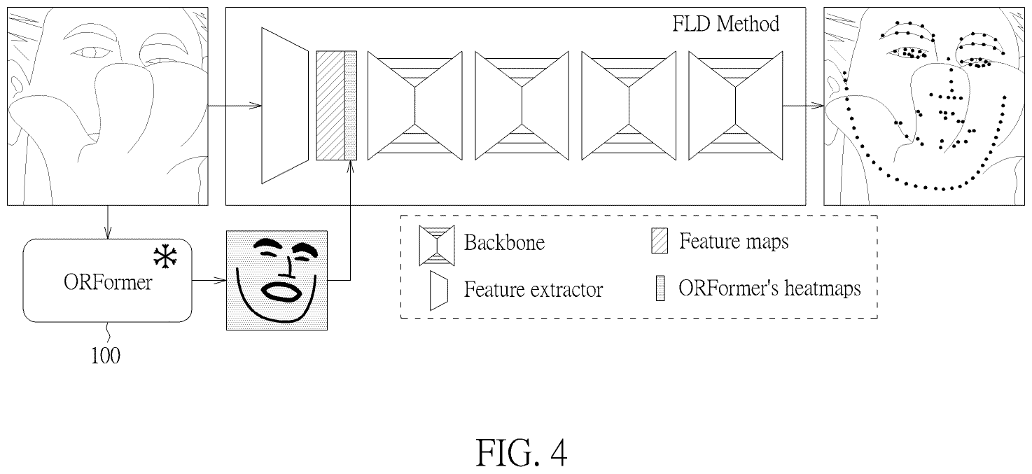

With the ORFormer 100 for occlusion detection and feature recovery, the quantized heatmap generator can produce high-quality heatmaps. To evaluate the effectiveness of the output heatmaps, they are integrated as additional structural guidance into existing FLD methods. As illustrated in FIG. 4, the integration involves merging the heatmaps produced by the heatmap generator and the feature maps yielded by an existing FLD method. Specifically, the heatmaps is concatenated with the feature maps in the early stage and merged with a single lightweight CNN block. Utilizing the merged features, the proposed method can model a more robust facial structure and enhance the performance of existing FLD methods, especially on occluded or partially non-visible faces.

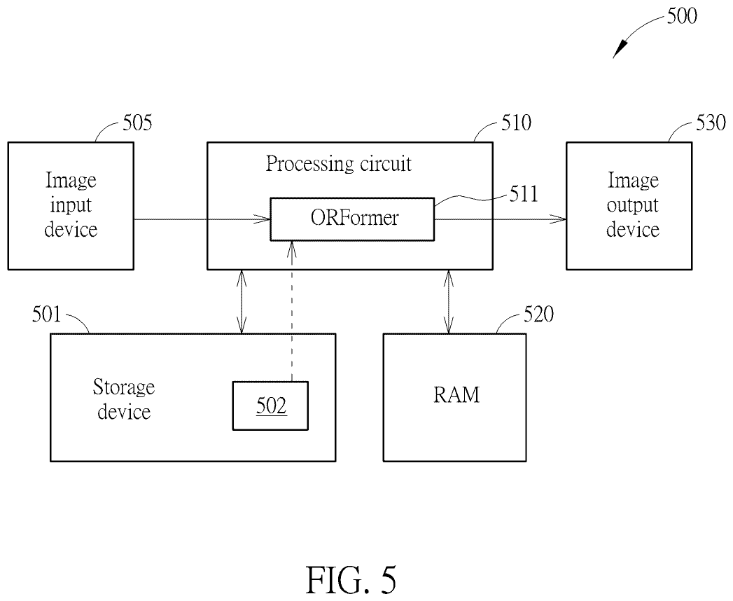

FIG. 5 is a diagram illustrating an electronic device 500 involved with the method according to an embodiment of the present invention. Examples of the electronic device 500 may include, but are not limited to: a personal computer (PC) such as a desktop computer and a laptop computer, a server, an all in one (AIO) computer, a tablet computer and a multifunctional mobile phone as well as a wearable device.

The electronic device 500 may comprise a processing circuit 510 that is capable of running an ORFormer framework 511 (labeled “ORFormer” in FIG. 5 for brevity) such as the whole framework shown in FIG. 4, with the whole architecture shown in FIG. 2(b) (illustrated with the key component thereof such as the ORFormer 100 in the lower left part of FIG. 4 for brevity) being integrated into the FLD architecture (i.e., the architecture of the FLD method) as shown in FIG. 4, and may further comprise a computer-readable medium such as a storage device 501, an image input device 505, a random access memory (RAM) 520 and an image output device 530. The processing circuit 510 may be arranged to control operations of the electronic device 500. More particularly, the computer-readable medium such as the storage device 501 may be arranged to store a program code 502, for being loaded onto the processing circuit 510 to act as the ORFormer framework 511 running on the processing circuit 510. When executed by the processing circuit 510, the program code 502 may cause the processing circuit 510 to operate according to the method, in order to perform the associated operations of the ORFormer framework 511. For example, multiple program modules may run on the processing circuit 510 for controlling the operations of the electronic device 500, where the ORFormer framework 511 may be one of the multiple program modules, but the present invention is not limited thereto. In addition, the image input device 505 may be arranged to input or receive multiple input images, the RAM 520 may be arranged to temporarily store the multiple input images, the ORFormer framework 511 running on the processing circuit 510 may be arranged to process the multiple input images, and more particularly, perform the occlusion-aware cross-attention processing on any input image among the multiple input images to obtain the occlusion map α for feature recovery by merging the feature maps (or the quantized features Z_{I} and Z_{M}) respectively corresponding to the code sequences S_{I} and S_{M} of the occluded and non-occluded image patches of the input image, in order to generate the facial landmark information regarding the facial landmark detection, for generating a corresponding output image among multiple output images, and the image output device 530 may be arranged to output or display the multiple output images, but the present invention is not limited thereto. For example, the RAM 520 may be arranged to temporarily store the multiple input images and the multiple output images, and/or the storage device 501 may be arranged to store the multiple input images and the multiple output images.

In the above embodiment, the storage device 501 can be implemented by way of a hard disk drive (HDD), a solid state drive (SSD) and a non-volatile memory such as a Flash memory, the image input device 505 can be implemented by way of a camera, the processing circuit 510 can be implemented by way of at least one processor, the RAM 520 can be implemented by way of a dynamic random access memory (DRAM), and the image output device 530 can be implemented by way of a display device such as a liquid-crystal display (LCD) panel, an organic light-emitting diode (OLED) panel, etc., where the display device can be implemented as a touch-sensitive panel, but the present invention is not limited thereto. According to some embodiments, the architecture of the electronic device 500 and/or the components therein may vary.

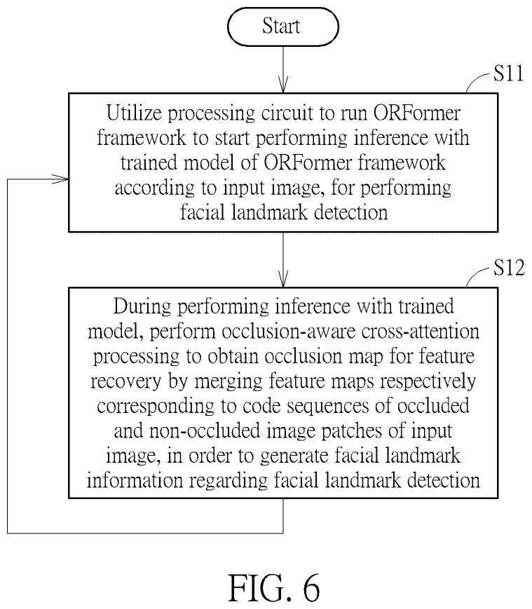

FIG. 6 is a flowchart of the method according to an embodiment of the present invention. The method can be applied to the electronic device 500 as well as the processing circuit 510 within the electronic device 500.

In Step S11, the electronic device 500 may utilize the processing circuit 510 to run the ORFormer framework 511 to start performing inference with the trained model of the ORFormer framework 511 according to at least one input image (e.g., at least one image among the multiple input images), for performing the facial landmark detection.

More particularly, the inference comprises inference of generating at least one occlusion-robust heatmap (e.g., the occlusion-robust heatmaps H_{rec}) according to the aforementioned at least one input image (e.g., the image I′ shown in FIG. 2(b)), for indicating at least one facial landmark of at least one face shown in the aforementioned at least one input image. For example, multiple stages of processing circuits (or processing circuit stages) regarding the inference of generating the aforementioned at least one occlusion-robust heatmap according to the aforementioned at least one input image, such as the series of stages {210, 220, 230, 240, 250} from the encoder to the decoder as shown in FIG. 2(b), may comprise an encoding stage 210 (e.g., the stage of the encoder E) and a decoding stage 250 (e.g., the stage of the decoder D) acting as the first stage and the last stage of the multiple stages, respectively, for encoding the aforementioned at least one input image into a predetermined space (e.g., the latent space Z∈R^{m×n×d}) regarding the inference and for decoding from the predetermined space, respectively.

In Step S12, during performing the inference with the trained model, the processing circuit 510 (or the ORFormer framework 511 running thereon) may perform the occlusion-aware cross-attention processing (e.g., the occlusion-aware cross-attention processing in the network architecture of the ORFormer 100 as shown in FIG. 3) on any input image among the aforementioned at least one input image to obtain the occlusion map α for feature recovery by merging the feature maps (or the quantized features Z_{I} and Z_{M}) respectively corresponding to two code sequences (e.g., the code sequences S_{I} and S_{M}) of the occluded and non-occluded image patches (or partial images) of the input image, in order to generate the facial landmark information regarding the facial landmark detection.

More particularly, the two code sequences comprise a first code sequence and a second code sequence such as the code sequences S_{I} and S_{M} shown in FIG. 2(b), and the two feature maps comprise a first feature map and a second feature map respectively corresponding to the first code sequence and the second code sequence, where the first feature map and the second feature map represent a first set of quantized feature and a second set of quantized feature such as the quantized features Z_{I} and Z_{M} shown in FIG. 2(b), respectively. In addition, the first code sequence such as the code sequence S_{I} is computed from the regular tokens and is arranged to bring the information of multiple encoded patches (e.g., all patches) of the aforementioned any input image, and the second code sequence such as the code sequence S_{M} is derived from the messenger tokens and is occlusion-aware.

Based on the codes in the two code sequences such as the code sequences S_{I} and S_{M} shown in FIG. 2(b), the two feature maps such as the quantized features Z_{I} and Z_{M} shown in FIG. 2(b) are produced by referring to a pre-learned codebook such as the codebook C shown in FIG. 2(b) in the trained model, respectively. Additionally, the two feature maps such as the quantized features Z_{I} and Z_{M} shown in FIG. 2(b) are merged by based on the occlusion map α in the patch-specific manner, and form the recovered feature Z_{rec}, for generating the aforementioned at least one occlusion-robust heatmap such as the occlusion-robust heatmaps H_{rec} by using the recovered feature along with a pre-trained decoder such as the decoder shown in FIG. 2(b) in the trained model. For example, the recovered feature Z_{rec} is yielded by merging the two feature maps such as the quantized features Z_{I} and Z_{M} shown in FIG. 2(b) with the patch-specific weights given in the occlusion map α, and is used for producing the aforementioned at least one occlusion-robust heatmap such as the occlusion-robust heatmaps H_{rec}.

Taking the input and the output images shown in the leftmost and the rightmost parts of FIG. 4 as examples of the aforementioned any input image and the corresponding output image, respectively, the corresponding output image can be changed or modified from the aforementioned any input image according to multiple facial landmark detection results of the accurate facial landmark detection, where the aforementioned at least one occlusion-robust heatmap such as the occlusion-robust heatmaps H_{rec} may comprise the multiple facial landmark detection results. The aforementioned multiple stages of processing circuits (or the processing circuit stages) regarding the inference, such as the series of stages {210, 220, 230, 240, 250} from the encoder to the decoder as shown in FIG. 2(b), can be arranged to act as the heatmap generator within the ORFormer framework 511 such as the whole framework shown in FIG. 4, for occlusion detection and feature recovery, resulting in generating the aforementioned at least one occlusion-robust heatmap such as the occlusion-robust heatmaps H_{rec}. With the aid of the heatmap generator integrated into the ORFormer framework 511, the ORFormer framework 511 can be arranged to refer to the aforementioned at least one input image and the aforementioned at least one occlusion-robust heatmap such as the occlusion-robust heatmaps H_{rec} to generate the aforementioned at least one facial landmark of the aforementioned at least one face shown in the aforementioned at least one input image.

Although there is a challenge that the feature maps from the non-visible regions are corrupted, the method of the present invention can utilize the ORFormer 100 to identify non-visible regions and recover their missing features via the messenger tokens Mᵢ as described above. For example, referring to FIG. 1(a), for each patch Pᵢ, the processing circuit 510 (or the ORFormer framework 511 running thereon) may introduce a patch token Xᵢ and a learnable messenger token Mᵢ for occlusion detection and handling; referring to FIG. 1(b) the messenger token may be arranged for computing attention with patch tokens other than its corresponding one; and referring to FIG. 1(c), the processing circuit 510 (or the ORFormer framework 511 running thereon) may detect occlusion by evaluating the dissimilarity between the regular embedding X′ᵢ and the messenger embedding M′ᵢ, and then recover occluded features based on the messenger embedding which is aggregated from other image patches, if occlusion is present in patch Pᵢ.

During the inference of generating the aforementioned at least one occlusion-robust heatmap according to the aforementioned at least one input image, the processing circuit 510 (or the ORFormer framework 511 running thereon) may perform the associated operations with the aid of the ORFormer 100, for example: the ORFormer framework 511 (or the ORFormer 100 therein) uses at least one messenger token Mᵢ to simulate occlusion present in at least one patch i and aggregate features from all patch tokens except at least one patch token Xᵢ corresponding to the aforementioned at least one patch i; regarding the detection, the ORFormer framework 511 (or the ORFormer 100 therein, which may be regarded as an ORFormer stage 220, acting as at least one next/subsequent stage of the encoding stage 210) takes the image patches P as inputs to generate the occlusion map α and the two code sequence S_{I} and S_{M}, and the ORFormer framework 511 (or a combination of the codebook C and an access control circuit thereof, collectively referred to as a codebook circuit, which may be regarded as a first subsequent stage 230, acting as the next stage of the ORFormer stage 220) decodes the two feature maps such as the quantized features Z_{I} and Z_{M} from the two code sequence S_{I} and S_{M}; and regarding the recovery, the ORFormer framework 511 (or the feature recovery module 12 therein, which may be regarded as a second subsequent stage 240, acting as the next stage of the first subsequent stage 230) merges the two feature maps such as the quantized features Z_{I} and Z_{M} with patch-specific weights given in the occlusion map α, to yield the recovered feature Z_{rec}, and the ORFormer framework 511 (or the decoder D therein, which may be regarded as the decoder stage 250, acting as the next stage of the second subsequent stage 240) produces the aforementioned at least one occlusion-robust heatmap such as the occlusion-robust heatmaps H_{rec} from the recovered feature Z_{rec}.

As shown in FIG. 6, the loop comprising Steps S11 and S12 can be executed multiple times, for processing various input images to generate corresponding output images, respectively. For brevity, similar descriptions for this embodiment are not repeated in detail here.

For better comprehension, the method may be illustrated with the working flow shown in FIG. 6, but the present invention is not limited thereto. According to some embodiments, one or more steps may be added, deleted, or changed in the working flow shown in FIG. 6. For example, after the associated processing of Steps S11 and S12 in a current iteration of the working flow shown in FIG. 6 is completed, when in Step S11 is re-entered in another iteration, the processing circuit 510 may selectively change the image source of the input image(s) to obtain another set of input image(s) as the input image(s) of the other iteration, and start performing the inference with the trained model according to the latest input image(s), for generating another set of output image(s) to be the latest output image(s) of the other iteration. For brevity, similar descriptions for these embodiments are not repeated in detail here.

According to some embodiments, as the quantized heatmap generator should be trained first as shown in FIG. 2(a), the associated steps regarding the training/pre-training of the trained model may be inserted into the working flow shown in FIG. 6 to be a partial working flow before Steps S11 and S12. More particularly, the method may comprise: before executing Steps S11 and S12 (or the loop thereof), training the quantized heatmap generator in advance, in order to learn prior knowledge from the original dataset to train the codebook C and the decoder D, where the quantized heatmap generator may take, by the encoder E, the image I as the input and generate its edge heatmaps H, and after the pre-training, the prior knowledge of unoccluded faces is encoded in the codebook C and decoder D. Regarding occluded faces, the trained model may be further trained with artificial occlusions, in order to generate the occlusion map α and the two code sequences S_{I} and S_{M}, Referring to FIG. 2(b), with the frozen codebook C and decoder D (respectively marked with the snowflake-like symbol to indicate the frozen state thereof for better comprehension), the processing circuit 510 (or the ORFormer framework 511 running thereon) may utilize the ORFormer 100 to generate the occlusion map α and the two code sequences S_{I} and S_{M}, leading to the quantized features Z_{I} and Z_{M}, where the recovered feature Z_{rec} is yielded by merging the quantized features Z_{I} and Z_{M} with the patch-specific weights given in the occlusion map α, and is used to produce the occlusion-robust heatmaps H_{rec} from the recovered feature Z_{rec}. Referring to FIG. 3, the processing circuit 510 (or the ORFormer framework 511 running thereon) may utilize the ORFormer 100 to take the image patches P as the input of the ORFormer 100 and generate the two code sequences S_{I} and S_{M} via the codebook prediction head 340, where the code sequence S_{I} can be computed by referring to the image patch tokens, the code sequence S_{M} can be computed by the messenger tokens, and the occlusion map α can represent the patch-specific occlusion likelihood and can be inferred by the occlusion detection head 330. For example, the layer count L of the L layers in the ORFormer 100 can be a positive integer that is greater than (in particular, much greater than) one, and the layer index l of the aforementioned each layer l can be an integer falling within the interval [0, (L-1)]. Regarding the inputs of the layer l for the case of l=0, X^{l}=X⁰=P while M^{l}=M⁰ in which M⁰ can be random, and α^{l}=α⁰=0 (which may indicate “visible”). During the inference mentioned above, the processing circuit 510 (or the ORFormer framework 511 running thereon) can perform codebook retrieving to select the quantized features Z_{I} and Z_{M} from the codebook C using the two code sequences S_{I} and S_{M}, respectively, for performing feature recovery as shown in Equation (9). Referring to FIG. 4, the processing circuit 510 (or the ORFormer framework 511 running thereon) may utilize the ORFormer 100 to perform the occlusion detection and the feature recovery, resulting in the high-quality heatmaps, where the generated heatmaps serve as an extra input to the FLD architecture, and offer the recovered features to make the FLD architecture robust to occlusions. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of occlusion-robust transformer for accurate facial landmark detection, the method being applied to a processing circuit within an electronic device, the method comprising:
utilizing the processing circuit to run an occlusion-robust transformer framework to start performing inference with a trained model of the occlusion-robust transformer framework according to at least one input image, for performing facial landmark detection; and
during performing the inference with the trained model, performing occlusion-aware cross-attention processing on any input image among the at least one input image to obtain an occlusion map for feature recovery by merging two feature maps respectively corresponding to two code sequences of occluded and non-occluded image patches of the any input image, in order to generate facial landmark information regarding the facial landmark detection.

2. The method of claim 1, wherein the inference comprises inference of generating at least one occlusion-robust heatmap according to the at least one input image, for indicating at least one facial landmark of at least one face shown in the at least one input image.

3. The method of claim 2, wherein multiple stages of processing circuits regarding the inference of generating the at least one occlusion-robust heatmap according to the at least one input image comprise an encoding stage and a decoding stage acting as a first stage and a last stage of the multiple stages, respectively, for encoding the at least one input image into a predetermined space regarding the inference and for decoding from the predetermined space, respectively.

4. The method of claim 1, wherein the two code sequences comprise a first code sequence and a second code sequence, and the two feature maps comprise a first feature map and a second feature map respectively corresponding to the first code sequence and the second code sequence.

5. The method of claim 4, wherein the first feature map and the second feature map represent a first set of quantized feature and a second set of quantized feature, respectively.

6. The method of claim 1, wherein the two code sequences comprise a first code sequence and a second code sequence, wherein the first code sequence is computed from regular tokens and is arranged to bring information of multiple encoded patches of the any input image, and the second code sequence is derived from messenger tokens and is occlusion-aware.

7. The method of claim 1, wherein based on codes in the two code sequences, the two feature maps are produced by referring to a pre-learned codebook in the trained model, respectively.

8. The method of claim 7, wherein the inference comprises inference of generating at least one occlusion-robust heatmap according to the at least one input image; and the two feature maps are merged by based on the occlusion map in a patch-specific manner, and form a recovered feature, for generating the at least one occlusion-robust heatmap by using the recovered feature along with a pre-trained decoder in the trained model.

9. The method of claim 8, wherein the recovered feature is yielded by merging the two feature maps with patch-specific weights given in the occlusion map, and is used for producing the at least one occlusion-robust heatmap.

10. The method of claim 1, wherein the inference comprises inference of generating at least one occlusion-robust heatmap according to the at least one input image, wherein multiple stages of processing circuits regarding the inference are arranged to act as a heatmap generator within the occlusion-robust transformer framework, for occlusion detection and feature recovery, resulting in generating the at least one occlusion-robust heatmap; and with aid of the heatmap generator integrated into the occlusion-robust transformer framework, the occlusion-robust transformer framework is arranged to refer to the at least one input image and the at least one occlusion-robust heatmap to generate at least one facial landmark of at least one face shown in the at least one input image.

11. The method of claim 1, wherein the inference comprises inference of generating at least one occlusion-robust heatmap according to the at least one input image; the two code sequences comprise a first code sequence and a second code sequence respectively corresponding to regular tokens and messenger tokens; and the method further comprises:
during the inference of generating the at least one occlusion-robust heatmap according to the at least one input image, using at least one messenger token to simulate occlusion present in at least one patch and aggregate features from all patch tokens except at least one patch token corresponding to the at least one patch.

12. The method of claim 1, wherein the inference comprises inference of generating at least one occlusion-robust heatmap according to the at least one input image; and the method further comprises:
during the inference of generating the at least one occlusion-robust heatmap according to the at least one input image, taking multiple image patches as inputs to generate the occlusion map and the two code sequence; and
during the inference of generating the at least one occlusion-robust heatmap according to the at least one input image, decoding the two feature maps from the two code sequence.

13. The method of claim 1, wherein the inference comprises inference of generating at least one occlusion-robust heatmap according to the at least one input image; and the method further comprises:
during the inference of generating the at least one occlusion-robust heatmap according to the at least one input image, merging the two feature maps with patch-specific weights given in the occlusion map to yield recovered feature; and
during the inference of generating the at least one occlusion-robust heatmap according to the at least one input image, producing the at least one occlusion-robust heatmap from the recovered feature.

14. An apparatus that operates according to the method of claim 1, wherein the apparatus comprises at least the processing circuit within the electronic device.

15. The apparatus of claim 14, wherein the apparatus comprises the electronic device.

16. A computer-readable medium related to the method of claim 1, wherein the computer-readable medium stores a program code which causes the processing circuit to operate according to the method when executed by the processing circuit.
